(19) United States
(12) Patent Application Publication
(10) Pub. No.: US 2007/0215761 A1
(43) Pub. Date: Sep. 20, 2007

(54) Display support mechanism

(75) Inventors: Kunio Sawai, Daito-shi (JP); Katsuyuki Yokota, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/717,209

(22) Filed: Mar. 13, 2007

(30) Foreign Application Priority Data
Mar. 14, 2006 (JP) 2006-068447

(51) Int. Cl. F16M 11/00

(52) U.S. Cl. 248/122.1

(57) ABSTRACT

A display support mechanism capable of inclining a display screen by a prescribed angle without employing a round shaft as an axis of rotation is obtained. This display support mechanism comprises a support shaft provided in the form of a plate, a display screen support member, supporting a display screen, having a sectoral first hole receiving the platelike support shaft and a base support member having a sectoral second hole receiving the platelike support shaft, while the display screen support member is rotatable about the support shaft serving as an axis of rotation in the total angular range of the sectoral first hole of the display screen support member and the sectoral second hole of the base support member.

### BACKGROUND OF THE INVENTION

1. Field of the Invention

The present invention relates to a display support mechanism.

2. Description of the Background Art

A display support mechanism capable of supporting a display screen in a state inclined by a prescribed angle is known in general, as disclosed in Japanese Patent Laying-Open No. 2005-140807, 2001-75486 or 2002-196686, for example.

The display support mechanism described in the aforementioned Japanese Patent Laying-Open No. 2005-140807 comprises a stand post mounted on the side of a base, another stand post mounted on the side of a display screen and a slidable link coupling the stand posts mounted on the sides of the base and the display screen respectively to each other to be rotatable about a round shaft. In the display support mechanism described in Japanese Patent Laying-Open No. 2005-140807, the link is slid in a first direction for fixing the angle of the display screen, and slid in a second direction for supporting the display screen in a state rotatable by 90°.

The display support mechanism described in the aforementioned Japanese Patent Laying-Open No. 2001-75486 comprises a hinge unit fixed to a base and a display screen for supporting the base and the display screen to be rotatable by 90°. This hinge unit has a member (base support member) fixed to the base and another member (display screen support member) fixed to the display screen. The member (base support member) fixed to the base and the member (display screen support member) fixed to the display screen are conceivably rotatably coupled to each other by a round shaft, although this is not clearly described.

The display support mechanism described in the aforementioned Japanese Patent Laying-Open No. 2002-196686 comprises a round shaft, rotatably supporting a display screen and a base, having a protrusion and an actuator regulating rotation of the round shaft. In this display support mechanism described in Japanese Patent Laying-Open No. 2002-196686, the normal rotatable angular range of the display screen is set to 40°. The display screen is released from the actuator, to be rotated by 90°.

In each of the display support mechanisms described in the aforementioned Japanese Patent Laying-Open Nos. 2005-140807, 2001-75486 and 2002-196686, however, the round shaft is employed as an axis of rotation and hence grooving or the like must be performed along the outer periphery of the round shaft for mounting a stop member such as a C-ring in order to prevent the round shaft from axial deviation, to disadvantageously result in complicated working of the axis of rotation.

### SUMMARY OF THE INVENTION

The present invention has been proposed in order to solve the aforementioned problem, and an object of the present invention is to provide a display support mechanism capable of inclining a display screen by a prescribed angle without employing a round shaft as an axis of rotation.

A display support mechanism according to a first aspect of the present invention comprises a support shaft provided in the form of a plate, a display screen support member, supporting a display screen, having a sectoral first hole receiving the platelike support shaft and a base support member, provided on the side of a base, having a sectoral second hole receiving the platelike support shaft, while the display screen support member is rotatable about the support shaft serving as an axis of rotation in the total angular range of the sectoral first hole of the display screen support member and the sectoral second hole of the base support member.

As hereinabove described, the display support mechanism according to the first aspect includes the support shaft provided in the form of a plate while the display screen support member supporting the display screen has the sectoral first hole receiving the platelike support shaft and the base support member provided on the side of the base has the sectoral second hole receiving the platelike support shaft, whereby the platelike support shaft can be employed as an axis of rotation. Thus, the display screen can be inclined by a prescribed angle without employing a round shaft as an axis of rotation. Further, the display screen support member, rendered rotatable about the platelike support shaft serving as an axis of rotation in the total angular range of the sectoral first hole of the display screen support member and the sectoral second hole of the base support member, can be rotated about the platelike support shaft in a large angular range without setting the first or second hole to a large angular range.

In the display support mechanism according to the first aspect, the angles of the sectoral first hole and the sectoral second hole are preferably less than 90°, and the total angle of the sectoral first hole and the sectoral second hole is preferably at least 90°. According to this structure, the display screen can be inclined by at least 90°. Thus, the base and the display screen can be arranged in parallel with each other. Therefore, the gross volume of the display support mechanism can be so reduced that the number of simultaneously carriable display support mechanisms can be increased in shipment.

The display support mechanism according to the first aspect is preferably so formed that the display screen support member and the support shaft first rotate about a bottom portion, serving as an axis of rotation, of the sectoral second hole of the base support member closer to the center of a circle in the angular range of the sectoral second hole of the base support member and the display screen support member thereafter rotates about a bottom portion, serving as an axis of rotation, of the sectoral first hole of the display screen support member closer to the center of a circle in the angular range of the sectoral first hole of the display screen support member when the display screen support member is rotated in a prescribed direction. According to this structure, both ends of the bottom portions of the first and second holes closer to the centers of the circles inhibit the support shaft from positional deviation of the center of rotation upon rotation of the display screen support member. Thus, the display screen support member and the support shaft can be easily rotated in a sectoral angular range.

In this case, the bottom portion of the first hole of the display screen support member is preferably located upward, the bottom portion of the second hole of the base support member is preferably located downward, and upper and lower portions of the platelike support shaft preferably come into contact with the bottom portion of the first hole of the display screen support member and the bottom portion of the second hole of the base support member respectively so that the bottom portion of the first hole of the display screen support member and the bottom portion of the second hole of the base support member receive the vertical load of the display screen. According to this structure, the vertical load of the display screen is applied to the bottom portions of the first and second holes serving as the centers of rotation, whereby the operation of rotating the display screen can be stabilized.

In the aforementioned structure rotating the display screen support member about the bottom portions of the sectoral first and second holes serving as axes of rotation, the radial length of the sectoral first hole and the radial length of the sectoral second hole are preferably rendered larger than the radial width of the platelike support shaft. According to this structure, the lower and upper portions of the support shaft having the upper and lower portions coming into contact with the bottom portions of the first and second holes respectively can be inhibited from coming into contact with arcuate portions of the first and second holes respectively. Thus, the operation of rotating the display screen can be stabilized.

In the aforementioned structure rotating the display screen support member about the bottom portions of the sectoral first and second holes serving as axes of rotation, the thickness of the platelike support shaft and the width of the bottom portions of the first hole and the second hole in the thickness direction of the support shaft are preferably substantially equal to each other. According to this structure, the support shaft can be inhibited from deviating from the bottom portions of the first and second holes serving as the centers of rotation. Thus, the operation of rotating the display screen can be stabilized.

In the display support mechanism according to the first aspect, the display screen support member and the base support member are preferably pressed against each other by a spring member. According to this structure, frictional force can be developed between the display screen support member and the base support member for inhibiting the display screen from rotation. Thus, the display screen can be inhibited from rotating by its own weight.

In this case, the display screen support member and the base support member are preferably pressed against each other from both sides by two spring members so arranged as to hold the display screen support member and the base support member therebetween. According to this structure, the display screen support member or the base support member pressed from both sides can be inhibited from deflection in either pressing direction as compared with a case where the display screen support member or the base support member is pressed from one side by a single spring member and deflected in the pressing direction. Thus, sliding surfaces of the display screen support member and the base support member can be inhibited from moving in the pressing directions of the spring members, whereby the operation of rotating the display screen can be stabilized.

In the display support mechanism according to the first aspect, the display screen may be a liquid crystal screen.

In the display support mechanism according to the first aspect, the support shaft is preferably made of sheet metal. According to this structure, the support shaft of sheet metal provided in the form of a plate is so easily borable or shapable by press working that no complicated working of the axis of rotation is required dissimilarly to a case of performing grooving or the like along the outer peripheral surface of a round shaft.

The display support mechanism according to the first aspect preferably further comprises a platelike stop member, the support shaft preferably includes a receiving hole receiving the stop member, and the stop member is preferably inserted into the receiving hole of the support shaft inserted into the first hole of the display screen support member and the second hole of the base support member, thereby preventing the support shaft from displacement. According to this structure, the easily workable platelike stop member can easily inhibit the support shaft from coming off the display screen support member and the base support member.

A display support mechanism according to a second aspect of the present invention comprises a display screen support member supporting a display screen, a base support member provided on the side of a base, a support shaft of sheet metal provided in the form of a plate and a spring member pressing the display screen support member and the base support member against each other, the display screen support member has a sectoral first hole receiving the platelike support shaft while a bottom portion of the sectoral first hole is located upward, the base support member has a sectoral second hole receiving the platelike support shaft while a bottom portion of the sectoral second hole is located downward, the display screen support member is rotatable about the support shaft serving as an axis of rotation in the total angular range of the sectoral first hole of the display screen support member and the sectoral second hole of the base support member, the display screen support member and the support shaft first rotate about a bottom portion, serving as an axis of rotation, of the sectoral second hole of the base support member closer to the center of a circle in the angular range of the sectoral second hole of the base support member and the display screen support member thereafter rotates about a bottom portion, serving as an axis of rotation, of the sectoral first hole of the display screen support member closer to the center of a circle in the angular range of the sectoral first hole of the display screen support member when the display screen support member is rotated in a prescribed direction, upper and lower portions of the platelike support shaft come into contact with the bottom portion of the first hole of the display screen support member and the bottom portion of the second hole of the base support member respectively so that the bottom portion of the first hole of the display screen support member and the bottom portion of the second hole of the base support member receive the vertical load of the display screen, the radial length of the sectoral first hole and the radial length of the sectoral second hole are rendered larger than the radial width of the platelike support shaft, the thickness of the platelike support shaft and the width of the bottom portions of the first hole and the second hole in the thickness direction of the support shaft are substantially equal to each other, the angles of the sectoral first hole and the sectoral second hole are less than 90°, and the total angle of the sectoral first hole and the sectoral second hole is at least 90°.

The display support mechanism according to the second aspect includes the support shaft provided in the form of a plate while the display screen support member supporting the display screen has the sectoral first hole receiving the platelike support shaft and the base support member provided on the side of the base has the sectoral second hole receiving the platelike support shaft, whereby the platelike support shaft can be employed as an axis of rotation. Thus, the display screen can be inclined by a prescribed angle without employing a round shaft as an axis of rotation. Further, the display screen support member, rendered rotatable about the platelike support shaft serving as an axis of rotation in the total angular range of the sectoral first hole of the display screen support member and the sectoral second hole of the base support member, can be rotated about the platelike support shaft in a large angular range without setting the first or second hole to a large angular range. Further, the angles of the sectoral first hole and the sectoral second hole are set to less than 90° and the total angle of the sectoral first hole and the sectoral second hole is set to at least 90°, whereby the display screen can be inclined by at least 90°. Thus, the base and the display screen can be arranged in parallel with each other. Therefore, the gross volume of the display support mechanism can be so reduced that the number of simultaneously carriable display support mechanisms can be increased in shipment.

Further, the display support mechanism according to the second aspect is so formed that the display screen support member and the support shaft first rotate about the bottom portion, serving as an axis of rotation, of the sectoral second hole of the base support member closer to the center of the circle in the angular range of the sectoral second hole of the base support member and the display screen support member thereafter rotates about the bottom portion, serving as an axis of rotation, of the sectoral first hole of the display screen support member closer to the center of the circle in the angular range of the sectoral first hole of the display screen support member when the display screen support member is rotated in the prescribed direction, whereby both ends of the bottom portions of the first and second holes closer to the centers of the circles inhibit the support shaft from positional deviation of the center of rotation upon rotation of the display screen support member. Thus, the display screen support member and the support shaft can be easily rotated in a sectoral angular range. In addition, the bottom portion of the first hole of the display screen support member is located upward, the bottom portion of the second hole of the base support member is located downward and the upper and lower portions of the platelike support shaft come into contact with the bottom portion of the first hole of the display screen support member and the bottom portion of the second hole of the base support member respectively so that the bottom portion of the first hole of the display screen support member and the bottom portion of the second hole of the base support member receive the vertical load of the display screen so that the vertical load of the display screen is applied to the bottom portions of the first and second holes serving as the centers of rotation, whereby the operation of rotating the display screen can be stabilized.

In the display support mechanism according to the second aspect, the radial length of the sectoral first hole and the radial length of the sectoral second hole are rendered larger than the radial width of the platelike support shaft, whereby the lower and upper portions of the support shaft having the upper and lower portions coming into contact with the bottom portions of the first and second holes respectively can be inhibited from coming into contact with arcuate portions of the first and second holes respectively. Thus, the operation of rotating the display screen can be stabilized. Further, the thickness of the platelike support shaft and the width of the bottom portions of the first hole and the second hole in the thickness direction of the support shaft are rendered substantially equal to each other, whereby the support shaft can be inhibited from deviating from the bottom portions of the first and second holes serving as the centers of rotation. Thus, the operation of rotating the display screen can be stabilized. In addition, the display screen support member and the base support member are pressed against each other by the spring member, whereby frictional force can be developed between the display screen support member and the base support member for inhibiting the display screen from rotation. Thus, the display screen can be inhibited from rotating by its own weight.

In the display support mechanism according to the second aspect, the display screen support member and the base support member are preferably pressed against each other from both sides by two spring members so arranged as to hold the display screen support member and the base support member therebetween. According to this structure, the display screen support member or the base support member pressed from both sides can be inhibited from deflection in either pressing direction as compared with a case where the display screen support member or the base support member is pressed from one side by a single spring member and deflected in the pressing direction. Thus, sliding surfaces of the display screen support member and the base support member can be inhibited from moving in the pressing directions of the spring members, whereby the operation of rotating the display screen can be stabilized.

In the display support mechanism according to the second aspect, the display screen may be a liquid crystal screen.

In the display support mechanism according to the second aspect, the support shaft is preferably made of sheet metal. According to this structure, the support shaft of sheet metal provided in the form of a plate is so easily borable or shapable by press working that no complicated working of the axis of rotation is required dissimilarly to a case of performing grooving or the like along the outer peripheral surface of a round shaft.

The display support mechanism according to the second aspect preferably further comprises a platelike stop member, the support shaft preferably includes a receiving hole receiving the stop member, and the stop member is preferably inserted into the receiving hole of the support shaft inserted into the first hole of the display screen support member and the second hole of the base support member, thereby preventing the support shaft from displacement. According to this structure, the easily workable platelike stop member can easily inhibit the support shaft from coming off the display screen support member and the base support member.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIGS. 1 and 2 are side elevational views showing the overall structure of a liquid crystal display provided with a display support mechanism according to an embodiment of the present invention;

FIG. 3 is a perspective view of the display support mechanism according to the embodiment shown in FIG. 1, from which a liquid crystal display portion is removed;

FIG. 4 is a perspective view showing the overall structure of the display support mechanism according to the embodiment shown in FIG. 1;

FIG. 5 is an exploded perspective view showing the overall structure of the display support mechanism according to the embodiment shown in FIG. 4;

FIG. 6 is a perspective view showing a stop member of the display support mechanism according to the embodiment shown in FIG. 4;

FIG. 7 is a sectional view taken along the line 100-100 in FIG. 4;

FIG. 8 is a front elevational view of a liquid crystal display portion support member of the display support mechanism according to the embodiment shown in FIG. 4;

FIG. 9 is a front elevational view of a base support member of the display support mechanism according to the embodiment shown in FIG. 4;

FIG. 10 partially illustrates the display support mechanism as viewed along arrow P in FIG. 4;

FIG. 11 is a sectional view taken along the line 200-200 in FIG. 4;

FIG. 12 partially illustrates the display support mechanism as viewed along arrow Q in FIG. 4; and

FIGS. 13 to 16 are sectional views for illustrating rotating operations of the display support mechanism according to the embodiment shown in FIG. 4.

### DESCRIPTION OF THE PREFERRED EMBODIMENTS

An embodiment of the present invention is now described with reference to the drawings.

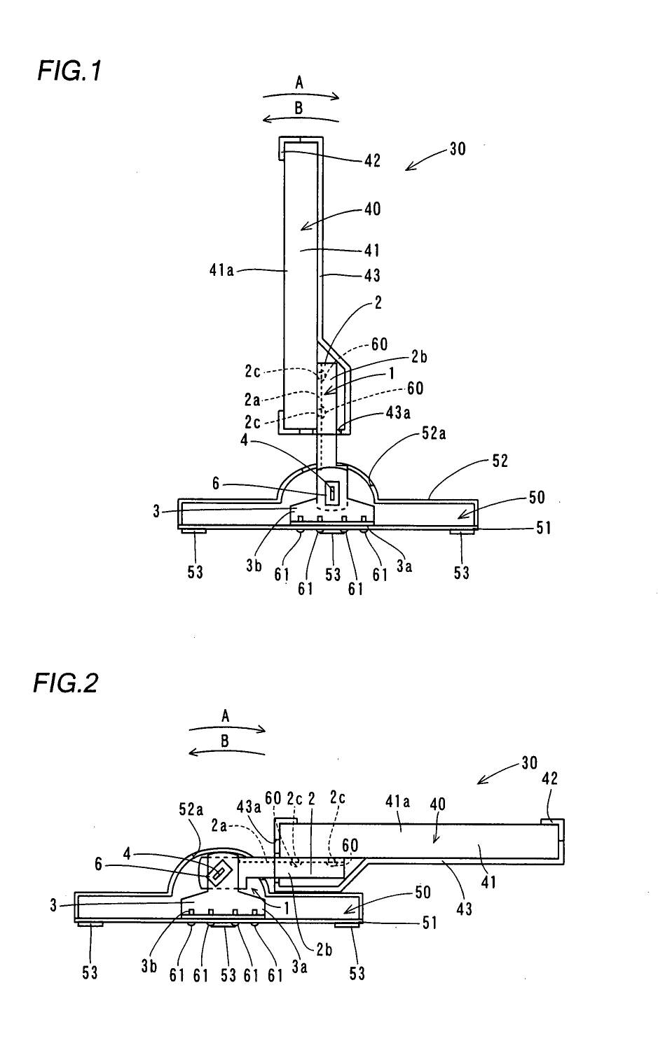

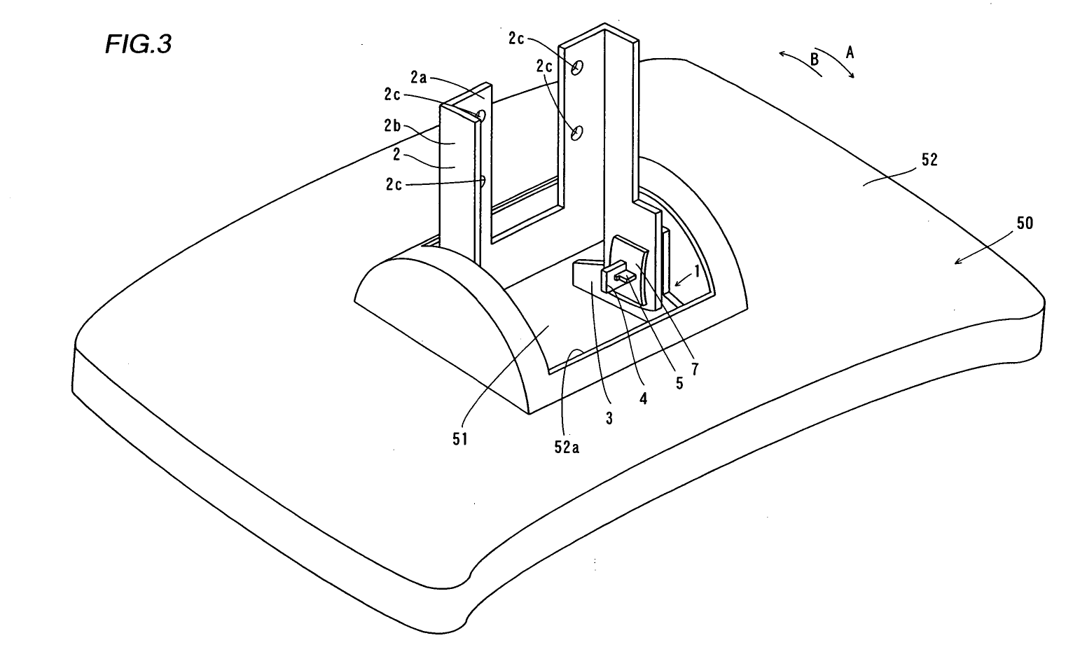

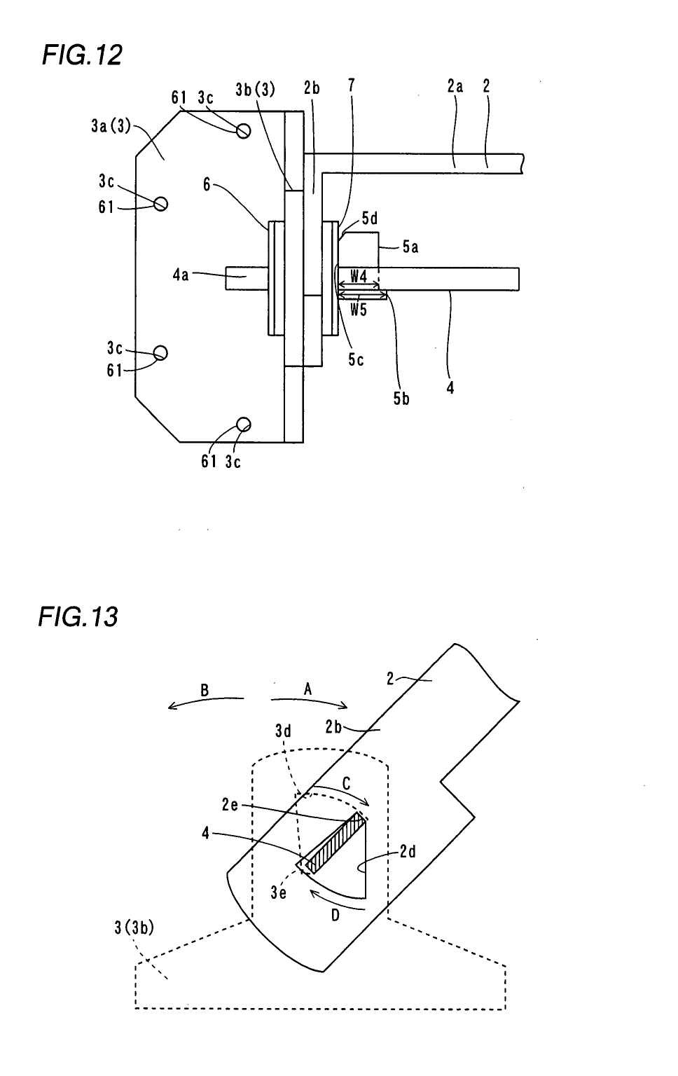

First, the structure of a display support mechanism 1 according to the embodiment of the present invention is described with reference to FIGS. 1 to 12.

The display support mechanism 1 according to the embodiment of the present invention is provided for supporting a liquid crystal display portion 40 of a liquid crystal display 30, as shown in FIG. 1. This display support mechanism 1 is mounted on a base 50. The display support mechanism 1 supports the liquid crystal display portion 40 to be rotatable by 90° in a direction A (see FIG. 2) or by 10° in a direction B with respect to the base 50. The display support mechanism 1 is enabled to support the liquid crystal display portion 40 in a state inclined by a prescribed angle with respect to the base 50.

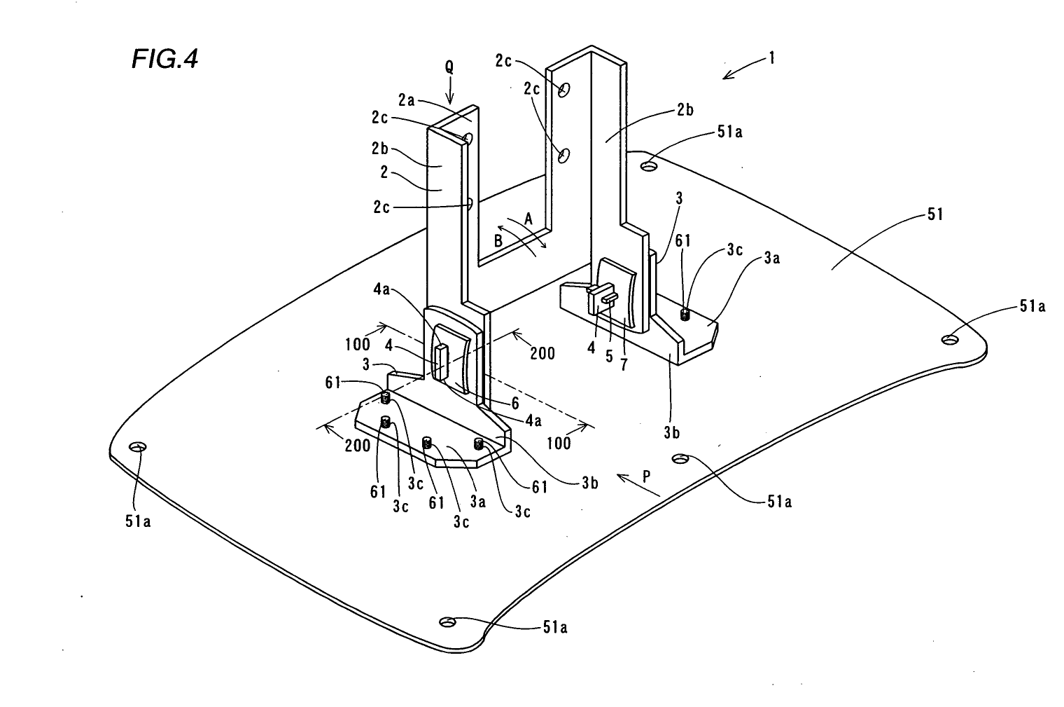

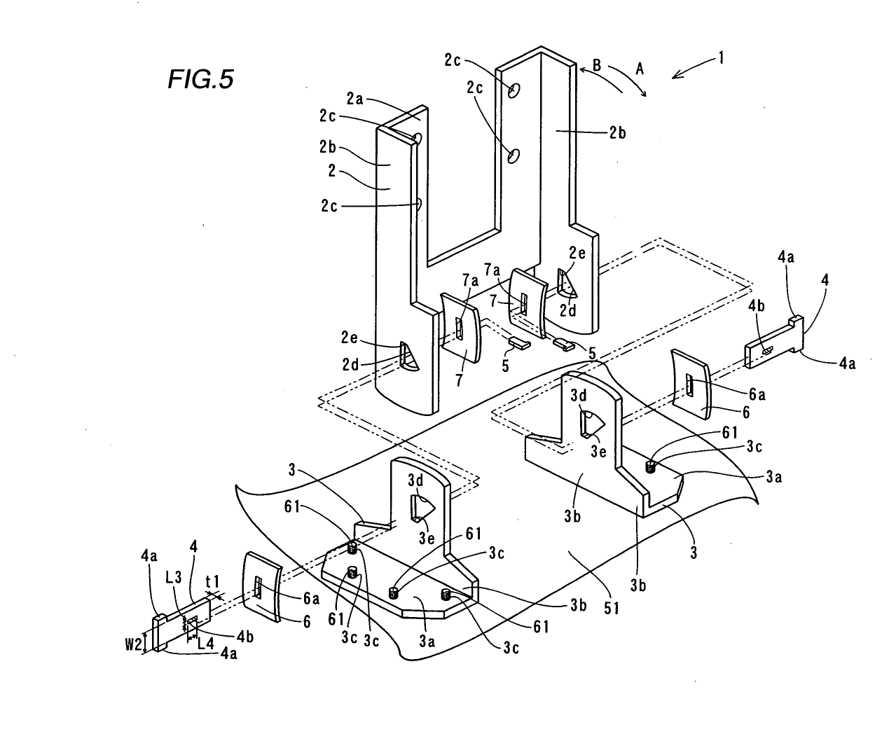

As shown in FIGS. 4 and 5, the display support mechanism 1 comprises a liquid crystal display portion support member 2, a pair of base support members 3, platelike support shafts 4 of sheet metal, stop members 5 of sheet metal, a pair of plate springs 6 arranged on the side of the base support members 3 and another pair of plate springs 7 arranged on the side of the liquid crystal display portion support member 2. The liquid crystal display portion support member 2 is an example of the “display screen support member” in the present invention.

The liquid crystal display portion support member 2 includes a display mounting portion 2a and a pair of rotational portions 2b, as shown in FIGS. 4 and 5. The display mounting portion 2a of the liquid crystal display portion support member 2 is provided with four screw receiving holes 2c. The pair of rotational portions 2b of the liquid crystal display portion support member 2 are so provided as to extend from both side ends of the display mounting portion 2a perpendicularly to the surface thereof respectively.

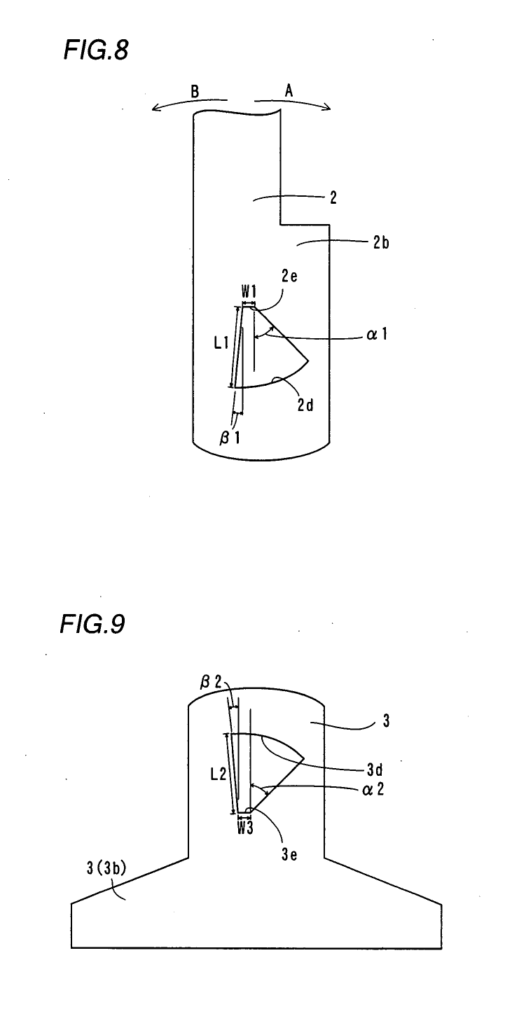

According to this embodiment, sectoral holes 2d are provided in the vicinity of the lower ends of the pair of rotational portions 2b of the liquid crystal display portion support member 2, as shown in FIG. 5. The holes 2d are examples of the “first hole” in the present invention. These sectoral holes 2d are provided for receiving the platelike support shafts 4, as shown in FIGS. 5 and 11. As shown in FIG. 7, each sectoral hole 2d is so arranged that a bottom portion 2e thereof closer to the center of a circle is located upward and comes into contact with the upper surface of the corresponding support shaft 4. Thus, the bottom portion 2e of the sectoral hole 2d receives the vertical load of the liquid crystal display portion 40 through the liquid crystal display portion support member 2. As shown in FIGS. 7 and 8, each sectoral hole 2d has a central angle α1 (45°) toward a first side from the vertical direction and another central angle β1 (5°) toward a second side from the vertical direction. The width W1 (see FIG. 8) of the bottom portion 2e of each sectoral hole 2d is substantially identical to the thickness t1 (see FIG. 5) of the corresponding support shaft 4 as described later, as shown in FIG. 7. The liquid crystal display portion support member 2 is rendered rotatable about the bottom portions 2e of the sectoral holes 2d supported by the platelike support shafts 4 in a sectoral angular range (α1+β1=50° in this embodiment) with respect to the support shafts 4. In other words, the platelike support shafts 4 function as the axes of rotation of the liquid crystal display portion support member 2. The radial length L1 (see FIG. 8) of each sectoral hole 2d is larger than the width W2 of the corresponding support shaft 4 as described later, as shown in FIG. 7. When the liquid crystal display portion support member 2 is rotated, therefore, the lower surfaces of the platelike support shafts 4 and arcuate portions of the sectoral holes 2d do not come into contact with each other.

The pair of base support members 3 include base mounting portions 3a and rotational portion mounting portions 3b respectively, as shown in FIGS. 4 and 5. Four screw mounting holes 3c are provided on the base mounting portion 3a of each base support member 3. The rotational portion mounting portions 3b of the base support members 3 are so provided as to vertically extend upward from first ends of the surfaces of the base mounting portions 3a.

According to this embodiment, sectoral holes 3d are provided on the rotational portion mounting portions 3b of the base support members 3. The holes 3d are examples of the “second hole” in the present invention. These sectoral holes 3d are provided for receiving the platelike support shafts 4, as shown in FIGS. 5 and 11. As shown in FIG. 7, each sectoral hole 3d is so arranged that a bottom portion 3e thereof closer to the center of a circle is located downward and comes into contact with the lower surface of the corresponding support shaft 4. Thus, the bottom portion 3e of the sectoral hole 3d receives the vertical load of the liquid crystal display portion 40 through the liquid crystal display portion support member 2 and the corresponding support shaft 4. In other words, the bottom portions 2e and 3e of the holes 2d and 3d of the liquid crystal display portion support member 2 and the base support members 3 receive the vertical load of the liquid crystal display portion 40 in this embodiment. As shown in FIGS. 7 and 9, each sectoral hole 3d has a central angle α2 (45°) toward the first side from the vertical direction and another central angle β2 (5°) toward the second side from the vertical direction. The width W3 (see FIG. 9) of the bottom portion 3e of each sectoral hole 3d is substantially identical to the thickness t1 (see FIG. 5) of the corresponding support shaft 4 as described later, as shown in FIG. 7. The support shafts 4 are rendered rotatable about the bottom portions 3e of the sectoral holes 3d in a sectoral angular range (α2+β2=50° in this embodiment) with respect to the base support members 3. The radial length L2 (see FIG. 8) of each sectoral hole 3d is larger than the width W2 (see FIG. 5) of the corresponding support shaft 4 as described later, as shown in FIG. 9. When the support shafts 4 are rotated, therefore, the upper surfaces of the platelike support shafts 4 and arcuate portions of the sectoral holes 3d do not come into contact with each other.

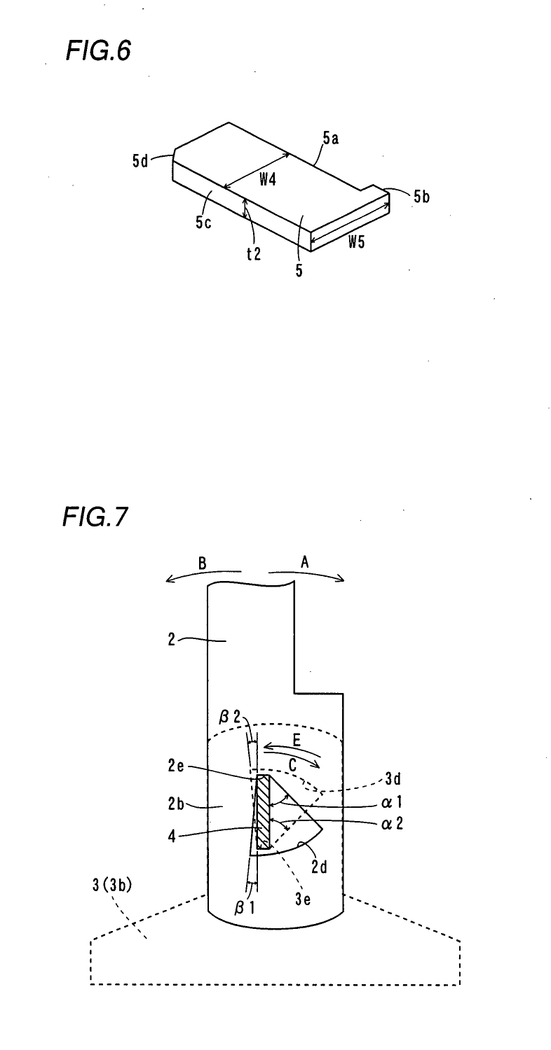

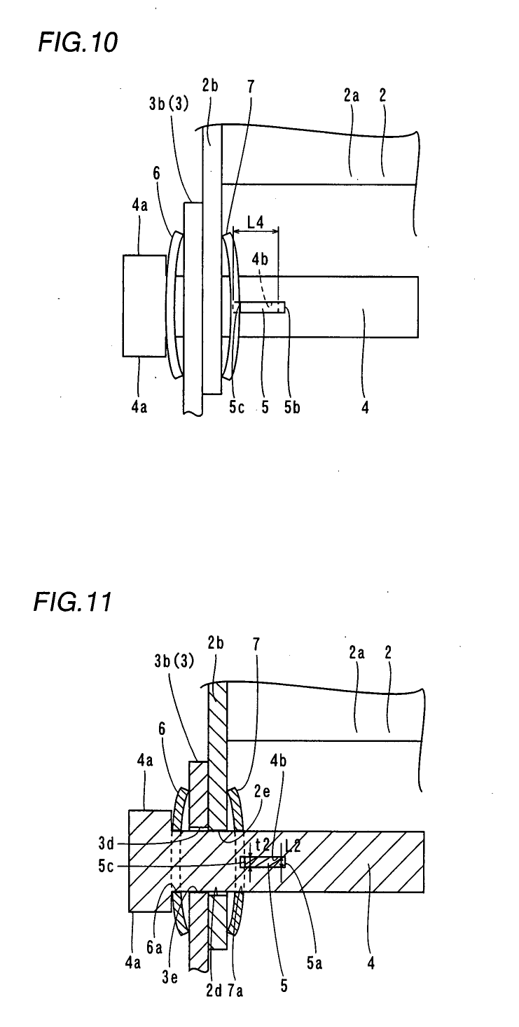

The platelike support shafts 4 of sheet metal include pairs of contact portions 4a and rectangular holes 4b, as shown in FIGS. 4 and 5. The pairs of contact portions 4a of the support shafts 4 are protrusively provided on rear ends of longitudinally extending side surfaces of the support shafts 4 respectively. Each contact portion 4a is provided for coming into contact with the plate spring 6 provided on the side of the corresponding base support member 3, as shown in FIGS. 10 to 12. The rectangular hole 4b of each support shaft 4 is provided for receiving the corresponding stop member 5, as shown in FIGS. 5 and 10 to 12. The short-directional length L3 (see FIG. 5) of the rectangular holes 4b is substantially identical to the thickness t2 (see FIG. 6) of the stop members 5, as described later. The holes 4b have a longitudinal length L4 (see FIG. 5) larger and smaller than widths W4 and W5 (see FIG. 6) of the stop members 5 respectively as described later.

As shown in FIG. 6, each stop member 5 of sheet metal, provided in the form of a plate, includes a contact portion 5b protruding from a longitudinally extending first side surface 5a and a chamfered portion 5d provided on a second side surface 5c. Further, each stop member 5 is inserted into the hole 4b of the corresponding support shaft 4 while holding the liquid crystal display portion support member 2, the corresponding base support member 3 and the corresponding plate springs 6 and 7 between the same and the contact portion 4a of the corresponding support shaft 4 and deflecting the corresponding plate springs 6 and 7, as shown in FIGS. 10 to 12. A portion of each stop member 5 corresponding to the contact portion 5a has the width W5 (see FIG. 6) larger than the longitudinal length L4 (FIG. 5) of the hole 4b of the corresponding support shaft 4. This contact portion 5a is provided for coming into contact with the surface of the corresponding support shaft 4 thereby inhibiting the stop member 5 from coming off the hole 4b of the corresponding support shaft 4 when the stop member 5 is inserted into the hole 4b of the corresponding support shaft 4. The second side surface 5c of the stop member 5 receives pressing force of the corresponding plate springs 6 and 7. The chamfered portion 5d is so provided that the stop member 5 can be easily inserted into the hole 4b of the corresponding support shaft 4.

The plate springs 6 and 7 are made of stainless steel. These plate springs 6 and 7 have rectangular holes 6a and 7a for receiving the support shafts 4 respectively, as shown in FIGS. 5 and 11. As hereinabove described, the stop members 5 are inserted into the holes 4b of the support shafts 4 while holding the liquid crystal portion support member 2, the base support members 3 and the plate springs 6 and 8 between the same and the contact portions 4a of the support shafts 4, thereby keeping the plate springs 6 and 7 in the deflected states. With spring force for restoring the deflected plate springs 6 and 7 to original shapes, the plate springs 6 and 7 press the liquid crystal display portion support member 2 and the base support members 3 from both sides to be rotatable about the platelike support shafts 4 serving as the axes of rotation. The plate springs 6 and 7 are examples of the “spring member” in the present invention.

The liquid crystal display portion 40 includes a liquid crystal module 41 including a liquid crystal screen 41a, a front cabinet 42 and a rear cabinet 43, as shown in FIGS. 1 and 2. The liquid crystal module 41 of the liquid crystal display portion 40 is mounted on the liquid crystal display portion support member 2 by fastening screws 60 to screw mounting holes (not shown) through the screw receiving holes 2c of the liquid crystal display portion support member 2. The rear cabinet 43 is provided with a notch 43a for receiving the liquid crystal display portion support member 2. The liquid crystal display portion 40 is an example of the “display screen” in the present invention.

The base 50 includes a base body 51, a cover member 52 and support legs 53, as shown in FIGS. 1 to 4. The base support members 3 are mounted on the base body 51 of the base 50 by fastening screws 61 to the screw mounting holes 3c of the base support members 3 through screw receiving holes (not shown) of the base body 51 from the side of the bottom surface. The cover member 52 of the base 50 is mounted on the base body 51 by fastening screws (not shown) to screw mounting holes (not shown) of the cover member 52 through screw receiving holes 51a of the base body 51 from the side of the bottom surface. The cover member 52 is provided with a notch 52a for receiving the liquid crystal display portion support member 2. This notch 52a is so formed that the liquid crystal display portion support member 2 and the cover member 52 do not come into contact with each other when the liquid crystal display potion 40 is rotated by 90° in the direction A or by 10° in the direction B. The support legs 53 are mounted on the bottom surface of the base body 51.

The rotating operations of the display support mechanism 1 according to the embodiment of the present invention are now described with reference to FIGS. 7 and 13 to 16.

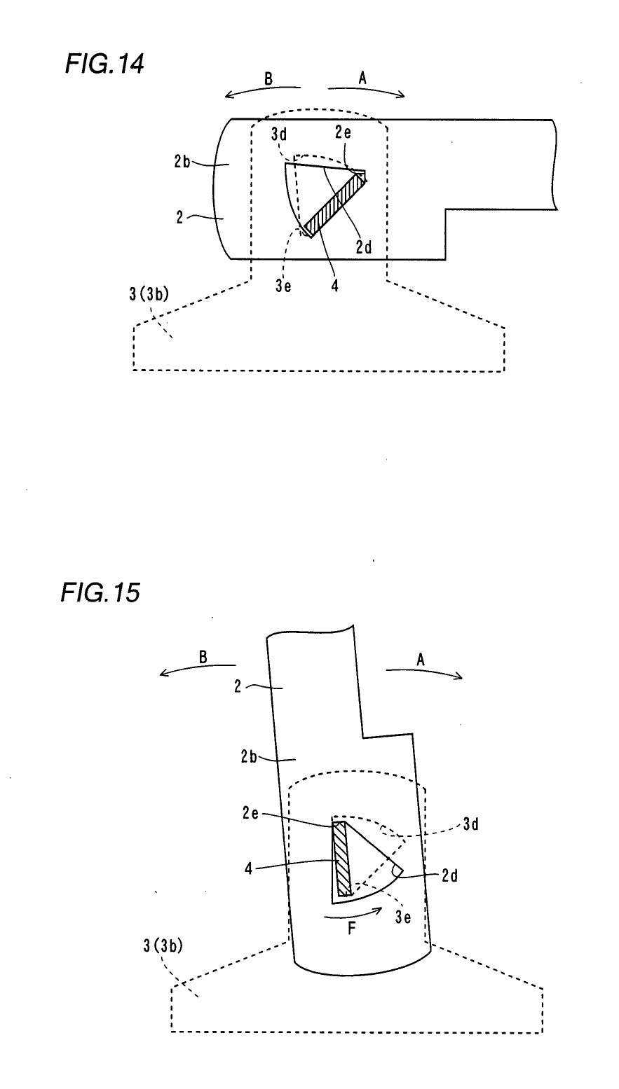

First, the user presses the liquid crystal display portion 40 in the direction A from the state where the liquid crystal display portion support member 2 is vertically supported as shown in FIG. 7. At this time, the bottom portions 2e of the sectoral holes 2d of the liquid crystal display portion support member 2 and the upper surfaces of the support shafts 4 come into contact with each other, so that the liquid crystal display portion support member 2 and the support shafts 4 are integrally rotated in a direction C about the bottom portions 3e of the sectoral holes 3d of the base support members 3. When the liquid crystal display portion support member 2 and the support shafts 4 are rotated by 45° (angle α2), the side surface of each support shaft 4 comes into contact with a first edge of the sectoral hole 3d of the corresponding base support member 3, as shown in FIG. 13. When the user further presses the liquid crystal display portion 40 in the direction A in this state, the liquid crystal display portion support member 2 is rotated about the bottom portion 2e of each sectoral hole 2d in a direction D with respect to each support shaft 4, as shown in FIG. 13. When the liquid crystal display portion support member 2 is rotated by 45° (angle α1) in the direction D, each support shaft 4 comes into contact with a first edge of each sectoral hole 2d of the liquid crystal display portion support member 2 for stopping the rotation in the direction A, as shown in FIG. 14. Thus, the liquid crystal display portion 40 is rotatable by 90° in the direction A according to this embodiment.

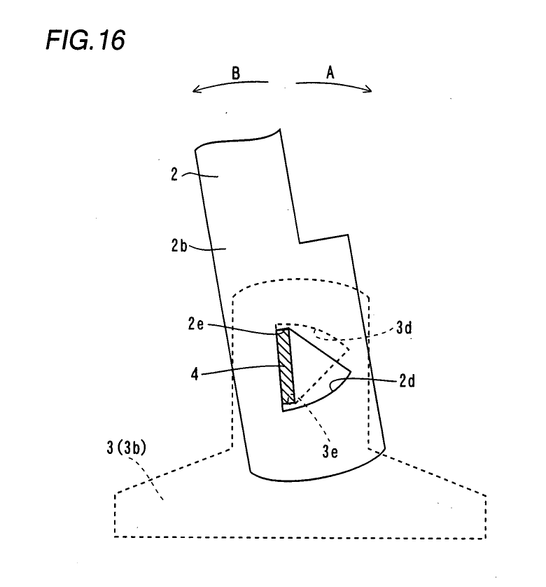

When the user presses the liquid crystal display portion 40 in the direction B from the state where the liquid crystal display portion support member 2 is vertically supported as shown in FIG. 7, on the other hand, the bottom portions 2e of the sectoral holes 2d of the liquid crystal display portion support member 2 and the upper surfaces of the support shafts 4 come into contact with each other, so that the liquid crystal display portion support member 2 and the support shafts 4 are integrally rotated in a direction E about the bottom portions 3e of the sectoral holes 3d of the base support members 3. When the liquid crystal display portion support member 2 and the support shafts 4 are rotated by 5° (angle β2), each support shaft 4 comes into contact with a second edge of the sectoral hole 3d of the corresponding base support member 3, as shown in FIG. 15. When the user further presses the liquid crystal display portion 40 in the direction B in this state, the liquid crystal display portion support member 2 is rotated about the bottom portion 2e of each sectoral hole 2d in a direction F with respect to each support shaft 4, as shown in FIG. 15. When the liquid crystal display portion support member 2 is rotated by 5° (angle β1) in the direction F, each support shaft 4 comes into contact with a second edge of each sectoral hole 2d of the liquid crystal display portion support member 2 for stopping the rotation in the direction B, as shown in FIG. 16. Thus, the liquid crystal display portion 40 is rotatable by 10° in the direction B according to this embodiment.

When the user stops pressing the liquid crystal display portion 40 at an arbitrary angle of rotation of 0° to 90° in the direction A of 0° to 10° in the direction B, the angle of rotation of the liquid crystal display portion support member 2 is maintained due to frictional force between the liquid crystal display portion support member 2 and the base support members 3 pressed against each other by the plate springs 6 and 7 as hereinabove described.

According to this embodiment, as hereinabove described, the display support mechanism 1 includes the platelike support shafts 4 of sheet metal provided in the form of plates while the liquid crystal display portion support member 2 supporting the liquid crystal display portion 40 has the sectoral holes 2d receiving the platelike support shafts 4 and the base support members 3 provided on the side of the base 50 have the sectoral holes 3d receiving the platelike support shafts 4, whereby the platelike support shafts 4 can be employed as the axes of rotation. Thus, the liquid crystal display portion 40 can be inclined by a prescribed angle without employing round shafts as axes of rotation. In this case, the support shafts 4 of sheet metal provided in the form of plates are so easily borable or shapable by press working that no complicated working of the axes of rotation is required dissimilarly to a case of performing grooving or the like along the outer peripheral surfaces of round shafts. Further, the liquid crystal display support member 2 is rendered rotatable about the platelike support shafts 4 serving as the axes of rotation in the total angular range (100°) of the sectoral holes 2d (50°) of the liquid crystal display portion support member 2 and the sectoral holes 3d (50°) of the base support members 3, whereby the liquid crystal display portion support member 2 can be rotated in the large angular range (100°) through the platelike support shafts 4 without setting the holes 2d or 3d to an angular range larger than 90°.

According to this embodiment, as hereinabove described, the sectoral holes 2d are so set that the angle toward the first edges thereof from the vertical direction is 45° and the sectoral holes 3d are also so set that the angle toward the first edges thereof from the vertical direction is 45°, whereby the liquid crystal display portion 40 can be inclined by 90° in the direction A. Thus, the base 50 and the liquid crystal display portion 40 can be arranged in parallel with each other, as shown in FIG. 2. Therefore, the gross volume of the display support mechanism 1 can be so reduced that the number of simultaneously carriable display support mechanisms can be increased in shipment.

According to this embodiment, as hereinabove described, the display support mechanism 1 is so formed that the liquid crystal display portion support member 2 and the support shafts 4 first rotate about the bottom portions 3e, serving as the axes of rotation, of the sectoral. holes 3d of the base support members 3 closer to the centers of the circles in the angular range of the sectoral holes 3d of the base support members 3 and the liquid crystal display portion support member 2 thereafter rotates about the bottom portions 2e, serving as the axes of rotation, of the sectoral holes 2d of the liquid crystal display portion support member 2 closer to the centers of the circles in the angular range of the sectoral holes 2d of the liquid crystal display portion support member 2 when the liquid crystal display portion support member 2 is rotated in the direction A or B, whereby both ends of the bottom portions 2e and 3e closer to the centers of the circles inhibit the support shafts 4 from positional deviation of the centers of rotation upon rotation of the liquid crystal display portion support member 2. Thus, the liquid crystal display portion support member 2 and the support shafts 4 can be easily rotated in the sectoral angular range.

According to this embodiment, as hereinabove described, the bottom portions 2e and 3e of the holes 2d and 3d of the liquid crystal display portion support member 2 and the base support members 3 receive the vertical load of the liquid crystal display portion 40 so that the vertical load of the liquid crystal display portion 40 is applied to the bottom portions 2e and 3e serving as the centers of rotation, whereby the operation of rotating the liquid crystal display portion 40 can be stabilized.

According to this embodiment, as hereinabove described, the radial length L1 of the sectoral holes 2d and 3d is rendered larger than the radial width W2 of the platelike support shafts 4, whereby the support shafts 4 can be inhibited from coming into contact with the arcuate portions of the holes 2d and 3d upon rotation of the liquid crystal display portion 40. Thus, the operation of rotating the liquid crystal display portion 40 can be stabilized.

According to this embodiment, as hereinabove described, the thickness t1 of the platelike support shafts 4 and the widths W1 and W3 of the bottom portions 2e and 3e of the holes 2d and 3d in the thickness direction of the support shafts 4 are substantially equalized to each other, whereby the support shafts 4 can be inhibited from deviating from the base portions 2e and 3e serving as the centers of rotation. Thus, the operation of rotating the liquid crystal display portion 40 can be stabilized.

According to this embodiment, as hereinabove described, the plate springs 6 and 7 press the liquid crystal display portion support member 2 and the base support members 3 against each other, whereby frictional force can be developed between the liquid crystal display portion support member 2 and the base support members 3 for inhibiting the liquid crystal display portion 40 from rotation. Thus, the liquid crystal display portion 40 can be inhibited from rotating by its own weight.

According to this embodiment, as hereinabove described, the pairs of plate springs 6 and 7 so arranged as to hold the liquid crystal display portion support member 2 and the base support members 3 therebetween press the liquid crystal display portion support member 2 and the base support members 3 against each other from both sides, whereby the liquid crystal display portion support member 2 or the base support members 3 can be inhibited from deflection in the pressing direction of either the plate springs 6 or the plate springs 7. Thus, sliding surfaces of the liquid crystal display portion support member 2 and the base support members 3 can be inhibited from moving in the pressing directions of the plate springs 6 and 7, whereby the operation of rotating the liquid crystal display portion 40 can be stabilized.

According to this embodiment, as hereinabove described, the stop members 5 are inserted into the holes 4b of the support shafts 4 inserted into the holes 2d and 3d of the liquid crystal display portion support member 2 and the base support members 3 thereby preventing the support shafts 4 from displacement, whereby the easily workable platelike stop members 5 can easily inhibit the support shafts 4 from coming off the liquid crystal display portion support member 2 and the base support members 3.

Although the present invention has been described and illustrated in detail, it is clearly understood that the same is by way of illustration and example only and is not to be taken by way of limitation, the spirit and scope of the present invention being limited only by the terms of the appended claims.

For example, while the display support mechanism is provided on the liquid crystal display in the aforementioned embodiment, the present invention is not restricted to this but the display support mechanism may alternatively be provided on a display such as an organic EL display or a plasma panel display other than the liquid crystal display.

While the sectoral holes 2d and 3d of the liquid crystal display support member 2 and the base support members 3 have the central angles of 45° (angles α1 and α2) toward the first side from the vertical direction respectively in the aforementioned embodiment, the present invention is not restricted to this but first holes of the display screen support member and second holes of the base support members may alternatively have central angles γ1 (<90°) and γ2 (<90°) (γ1+γ2≧90°) toward the first or second side from the vertical direction. According to this structure, a display screen can be easily horizontally arranged by rotating the same by at least 90° from a vertical position.

While the pairs of plate springs 6 and 7 hold the liquid crystal display portion support member 2 and the base support members 3 therebetween to press the same against each other in the aforementioned embodiment, the present invention is not restricted to this but the display support mechanism 1 may alternatively be provided with only either the plate springs 6 or the plate springs 7, or with spring members other than the plate springs 6 and 7.

What is claimed is:

1. A display support mechanism comprising:
a support shaft provided in the form of a plate;
a display screen support member, supporting a display screen, having a sectoral first hole receiving said platelike support shaft; and
a base support member, provided on the side of a base, having a sectoral second hole receiving said platelike support shaft, wherein
said display screen support member is rotatable about said support shaft serving as an axis of rotation in the total angular range of said sectoral first hole of said display screen support member and said sectoral second hole of said base support member.

2. The display support mechanism according to claim 1, wherein
the angles of said sectoral first hole and said sectoral second hole are less than 90°, and the total angle of said sectoral first hole and said sectoral second hole is at least 90°.

3. The display support mechanism according to claim 1, so formed that said display screen support member and said support shaft first rotate about a bottom portion, serving as an axis of rotation, of said sectoral second hole of said base support member closer to the center of a circle in the angular range of said sectoral second hole of said base support member and said display screen support member thereafter rotates about a bottom portion, serving as an axis of rotation, of said sectoral first hole of said display screen support member closer to the center of a circle in the angular range of said sectoral first hole of said display screen support member when said display screen support member is rotated in a prescribed direction.

4. The display support mechanism according to claim 3, wherein
said bottom portion of said first hole of said display screen support member is located upward,
said bottom portion of said second hole of said base support member is located downward, and
upper and lower portions of said platelike support shaft come into contact with said bottom portion of said first hole of said display screen support member and said bottom portion of said second hole of said base support member respectively so that said bottom portion of said first hole of said display screen support member and said bottom portion of said second hole of said base support member receive the vertical load of said display screen.

5. The display support mechanism according to claim 3, wherein
the radial length of said sectoral first hole and the radial length of said sectoral second hole are rendered larger than the radial width of said platelike support shaft.

6. The display support mechanism according to claim 3, wherein
the thickness of said platelike support shaft and the width of said bottom portions of said first hole and said second hole in the thickness direction of said support shaft are substantially equal to each other.

7. The display support mechanism according to claim 1, wherein
said display screen support member and said base support member are pressed against each other by a spring member.

8. The display support mechanism according to claim 7, wherein
said display screen support member and said base support member are pressed against each other from both sides by two said spring members so arranged as to hold said display screen support member and said base support member therebetween.

9. The display support mechanism according to claim 1, wherein
said display screen includes a liquid crystal screen.

10. The display support mechanism according to claim 1, wherein
said support shaft is made of sheet metal.

11. The display support mechanism according to claim 1, further comprising a platelike stop member, wherein
said support shaft includes a receiving hole receiving said stop member, and
said stop member is inserted into said receiving hole of said support shaft inserted into said first hole of said display screen support member and said second hole of said base support member, thereby preventing said support shaft from displacement.

12. A display support mechanism comprising:
a display screen support member supporting a display screen;
a base support member provided on the side of a base;
a support shaft of sheet metal provided in the form of a plate; and
a spring member pressing said display screen support member and said base support member against each other, wherein
said display screen support member has a sectoral first hole receiving said platelike support shaft while a bottom portion of said sectoral first hole is located upward,
said base support member has a sectoral second hole receiving said platelike support shaft while a bottom portion of said sectoral second hole is located downward,
said display screen support member is rotatable about said support shaft serving as an axis of rotation in the total angular range of said sectoral first hole of said display screen support member and said sectoral second hole of said base support member,
said display screen support member and said support shaft first rotate about a bottom portion, serving as an axis of rotation, of said sectoral second hole of said base support member closer to the center of a circle in the angular range of said sectoral second hole of said base support member and said display screen support member thereafter rotates about a bottom portion, serving as an axis of rotation, of said sectoral first hole of said display screen support member closer to the center of a circle in the angular range of said sectoral first hole of said display screen support member when said display screen support member is rotated in a prescribed direction,
upper and lower portions of said platelike support shaft come into contact with said bottom portion of said first hole of said display screen support member and said bottom portion of said second hole of said base support member respectively so that said bottom portion of said first hole of said display screen support member and said bottom portion of said second hole of said base support member receive the vertical load of said display screen,
the radial length of said sectoral first hole and the radial length of said sectoral second hole are rendered larger than the radial width of said platelike support shaft,
the thickness of said platelike support shaft and the width of said bottom portions of said first hole and said second hole in the thickness direction of said support shaft are substantially equal to each other, and
the angles of said sectoral first hole and said sectoral second hole are less than 90°, and the total angle of said sectoral first hole and said sectoral second hole is at least 90°.

13. The display support mechanism according to claim 12, wherein
said display screen support member and said base support member are pressed against each other from both sides by two said spring members so arranged as to hold said display screen support member and said base support member therebetween.

14. The display support mechanism according to claim 12, wherein
said display screen includes a liquid crystal screen.

15. The display support mechanism according to claim 12, wherein
said support shaft is made of sheet metal.

16. The display support mechanism according to claim 12, further comprising a platelike stop member, wherein
said support shaft includes a receiving hole receiving said stop member, and
said stop member is inserted into said receiving hole of said support shaft inserted into said first hole of said display screen support member and said second hole of said base support member, thereby preventing said support shaft from displacement.
